(19) United States
(12) Patent Application Publication
(10) Pub. No.: US 2011/0263309 A1
(43) Pub. Date: Oct. 27, 2011

(54) RUNTIME DOWNLOADABLE MOTION CONTROL PROFILES

(75) Inventor: Scott T. Gowin, Reno, NV (US)

(73) Assignee: IGT, Reno, NV (US)

(21) Appl. No.: 12/768,589

(22) Filed: Apr. 27, 2010

(51) Int. Cl. A63F 9/24; G05B 19/18

(52) U.S. Cl. 463/16; 318/569; 463/42

(57) ABSTRACT

Methods and apparatus for controlling motion-generating devices in gaming machines are disclosed. A gaming apparatus includes a main processor board, a CPU operable to execute a game of chance, a motion generating device, a first memory configured to store at least one first motion control profile that describes movement of the motion generating device, a motion control board coupled to the main processor board by an interface bus, the motion control board including a second memory configured to store at least one second motion control profile, and transfer logic configured to: receive the at least one first motion control profile via the bus in response to a gaming event, generate the at least one second motion control profile based upon the at least one first motion control profile, and store the at least one second motion control profile in the second memory; and motion control logic configured to cause the motion generating device to move in accordance with the at least one second motion control profile.

### FIELD OF THE INVENTION

The present invention relates generally to methods and devices for providing games, such as wagering games.

### BACKGROUND

Electronic gaming machines, such as slot machines and other mechanical wager-based gaming machines, can use moving parts such as rotatable reels and wheels imprinted with symbols of numbers or other indicia of game state to display or otherwise indicate the state and progress of games of chance. The motion varies as the game progresses. For example, a slot machine may have three reels that rotate to show different symbols in a window of the slot machine. The reels remain at rest when no game is in progress, and rotate when a player starts a game, e.g., by pressing a “Spin” button. After a period of time, the reels stop rotating, and the outcome of the game is indicated by the symbols on the portions of the reels that are visible through the window. The stopping position of the reels at the end of the rotational motion represents the game outcome, and the outcome is subject to specific regulatory restrictions and thereby is ordinarily determined by a random number generator independently of the motion of the reels. Therefore, the reels should appear to rotate in smooth, continuous motion or in other controlled patterns to stop at a position that corresponds to the determined game outcome, and precise control of the reel rotation is needed. Stepper motors have been introduced as one approach to achieving such precise control. A stepper motor rotates by discrete, defined angular distances each time power is applied to the motor. An appearance of smooth motion can be achieved by applying power to a stepper motor at appropriate times.

### SUMMARY

Some wager-based gaming machines described herein include a motion generating device, such as a stepper motor. Different games to be played on the gaming machine or different modes of a game can specify different characteristics for the motion to be generated, e.g., longer acceleration, faster acceleration or deceleration, or jittery motion. The motion control logic causes the motion generating device to move in accordance with data and/or instructions specified by the game, e.g., by computer program code that implements the game. The data and/or instructions that specify a particular motion pattern are referred to as a motion control profile.

The motion generating device is configured to load one or more motion control profiles during operation of the gaming machine, e.g., between games or while a game is in progress, to change characteristics of the motion, e.g., the reel spin speed, acceleration, and deceleration. Each profile describes or specifies a particular segment of motion, such as an acceleration segment, a deceleration segment, a constant speed segment, a jittery motion segment, and the like. A profile may be, for example, a list of time durations that specify delay times between successive applications of power to the stepper motor. In one implementation, the motion generating device is controlled by a motion control circuit board that interfaces with a main circuit board of the gaming machine. Profiles can then be loaded from a main memory located on the main circuit board into a controller memory located on the control board via an interface bus to change the characteristics of subsequent motion.

In general, in a first aspect, the invention features a gaming apparatus that includes a main processor board, a CPU to execute game logic that implements a game of chance, a motion generating device, a first memory configured to store at least one first motion control profile that describes movement of the motion generating device, a motion control board coupled to the main processor board by an interface bus, the motion control board including a second memory configured to store at least one second motion control profile, and transfer logic configured to do the following: receive the at least one first motion control profile in response to a gaming event, generate the at least one second motion control profile based upon the at least one first motion control profile, and store the at least one second motion control profile in the second memory; the motion control board also includes motion control logic configured to cause the motion generating device to move in accordance with the at least one second motion control profile.

Embodiments of the invention may include one or more of the following features. The at least one second motion control profile may be a copy of the at least one first motion control profile. The transfer logic may be further configured to receive the at least one first motion control profile via the interface bus. The gaming event may include receiving input from a player input device and/or receiving new or updated game logic. The at least one first motion control profile may include at least one predetermined time value. The motion generating device may be a stepper motor, and the motion control logic may be configured to cause the stepper motor to rotate by a step for each individual time value included in the second motion control profile when a period of time corresponding to and based upon the individual time value has elapsed. The at least one second motion control profile may include a first labeled profile associated with a first label, and the motion control logic may be configured to cause the motion generating device to move in accordance with the first labeled profile in response to receiving from the CPU a motion control command that includes the first label. The at least one second motion control profile may further include a second labeled profile associated with a second label, and the motion control logic may be configured to cause the motion generating device to move in accordance with the second labeled profile in response to receiving from the CPU a motion control command that includes the second label. The bus may be a Universal Serial Bus (USB). The transfer logic may be located on the main processor board, the motion control board, or a combination thereof.

The gaming apparatus may further include a network interface to receive the at least one first motion control profile from a server-based network, and the gaming event may include receiving the at least one first motion control profile from the server-based network. The at least one first motion control profile may be verified to be within the performance capabilities of the motion generating device.

In general, in a second aspect, the invention features a gaming machine to play a game of chance. The gaming machine includes a main processor board, a CPU to execute game logic that implements a game of chance, a motion generating device, a first memory configured to store at least one first motion control profile, a second memory configured to store at least one second motion control profile, where the first and second motion control profiles describe movement of the motion generating device, a value input device capable of receiving value, a player input device to place a wager on the game of chance, a value output device capable of outputting value associated with play of the game of chance, and a controller coupled to the main processor board by an interface bus, the controller configured to receive the at least one first motion control profile in response to a gaming event, generate the at least one second motion control profile based upon the at least one first motion control profile, store the at least one second motion control profile in the second memory, and cause the motion generating device to move in accordance with the at least one second motion control profile.

Embodiments of the invention may include one or more of the following features. The at least one second motion control profile may be a copy of the at least one first motion control profile. The controller may be further configured to receive the at least one first motion control profile via the interface bus. The gaming event may include receiving input via the player input device and/or receiving new or updated game logic. The at least one first motion control profile may include at least one predetermined time value. The motion generating device may be a stepper motor, and the controller may be further configured to cause the stepper motor to rotate by a step for each individual time value included in the second motion control profile when a period of time corresponding to and based upon the individual time value has elapsed. The at least one second motion control profile may include a first labeled profile associated with a first label, and the controller may be further configured to cause the motion generating device to move in accordance with the first labeled profile in response to receiving from the CPU a motion control command that includes the first label. The at least one second motion control profile may further include a second labeled profile associated with a second label, and the controller may be further configured to cause the motion generating device to move in accordance with the second labeled profile in response to receiving from the CPU a motion control command that includes the second label. The bus may be a Universal Serial Bus (USB). The gaming machine may further include a network interface to receive the at least one first motion control profile from a server-based network, wherein the gaming event includes receiving the at least one first motion control profile from the server-based network. The at least one first motion control profile may be verified to be within the performance capabilities of the motion generating device.

In general, in a third aspect, the invention features a system, including a host device, a plurality of gaming machines to play games of chance, each gaming machine including a main processor board, a CPU to execute game logic that implements a game of chance, a motion generating device, a first memory configured to store at least one first motion control profile, a second memory configured to store at least one second motion control profile, where the first and second motion control profiles describe movement of the motion generating device, a value input device capable of receiving value, a player input device to place a wager on the game of chance, a value output device capable of outputting value associated with play of the game of chance, a memory configured for storing a transaction log file containing one or more log entries, and a controller coupled to the main processor board by an interface bus, the controller configured to receive the at least one first motion control profile in response to a gaming event, generate the at least one second motion control profile based upon the at least one first motion control profile, store the at least one second motion control profile in the second memory; and cause the motion generating device to move in accordance with the at least one second motion control profile.

These and other methods of the invention may be implemented by various types of hardware, software, firmware, etc. For example, some features of the invention may be implemented, at least in part, by machine-readable media that contain program instructions, state information, etc., for performing various operations described herein. Examples of program instructions include both machine code, such as produced by a compiler, and files containing higher-level code that may be executed by the computer using an interpreter. Examples of machine-readable media include, but are not limited to, magnetic media such as hard disks, floppy disks, and magnetic tape; optical media such as CD-ROM disks; magneto-optical media; and hardware devices that are specially configured to store program instructions, such as read-only memory devices (“ROM”) and random access memory (“RAM”).

### BRIEF DESCRIPTION OF THE DRAWINGS

FIG. 1 is a block diagram that illustrates an electronic gaming machine and a motion control device in accordance with embodiments of the invention.

FIG. 2A is a block diagram that illustrates an electronic gaming machine and motion control board implemented using logic components in accordance with embodiments of the invention.

FIG. 2B is a block diagram that illustrates a motion control board implemented using a microprocessor and program code in accordance with embodiments of the invention.

FIG. 2C is a block diagram that illustrates a motion control board implemented using a microprocessor and program code loaded from a mainboard in accordance with embodiments of the invention.

FIG. 3 is a flow diagram of a motion control profile transfer process in accordance with embodiments of the invention.

FIG. 4 is a flow diagram of a motion control process in accordance with embodiments of the invention.

FIGS. 5A-5C depict an example of a gaming machine and related devices that may be used in accordance with embodiments of the invention.

FIG. 5D is a block diagram depicting a slot reel gaming peripheral and its connection over a communication network to a master gaming controller that may be used in accordance with embodiments of the invention.

FIG. 6 illustrates a gaming establishment and related devices that may be used in accordance with embodiments of the invention.

FIG. 7 illustrates an example of an arbiter and related devices that may be used in accordance with embodiments of the invention.

FIG. 8 depicts a network device that may be used in accordance with embodiments of the invention.

### DETAILED DESCRIPTION

While the present invention will be described with reference to a few specific embodiments, the description is illustrative of the invention and is not to be construed as limiting the invention. Various modifications to the present invention can be made to the preferred embodiments without departing from the true spirit and scope of the invention as defined by the appended claims For example, the steps of methods shown and described herein are not necessarily performed in the order indicated. It should also be understood that the methods of the invention may include more or fewer steps than are indicated.

Device functionality may be apportioned by grouping or dividing tasks in any convenient fashion. Therefore, when steps are described herein as being performed by a single device (e.g., a single printer, gaming machine, handheld device or server), the steps may alternatively be performed by multiple devices and vice versa.

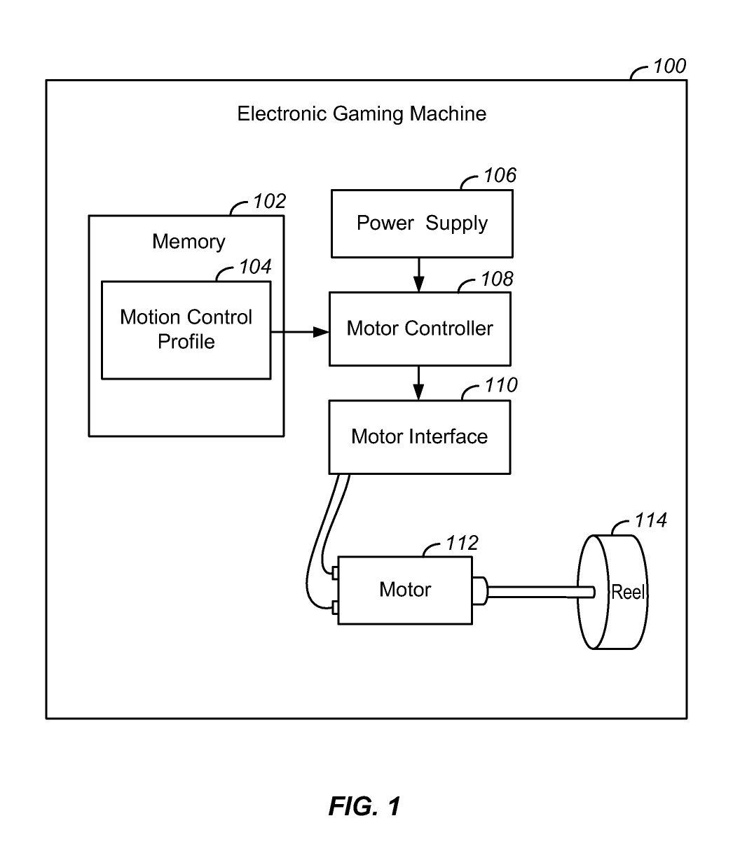

As illustrated in FIG. 1, an electronic gaming machine (“EGM”) 100 has movable components, such as reels and wheels 114 labeled with numbers and symbols. Such movable components are ordinarily driven by electro-mechanical motion generating devices, such as a stepper motor 112, which can rotate the reels or wheels 114 by a fraction of a 360° turn each time an electrical pulse is applied to the motor by a motor interface 110. A power supply 106 powers the components of the electronic gaming machine 100, including the motor 112. Although the motor 112 starts and stops rotating in each step, the time duration of each step can be made sufficiently small so the steps appear to form a continuous motion. The pulses can thus be applied in rapid succession to create an appearance that the reel or wheel 114 is spinning continuously for a period of time as part of a game of slots, roulette, or other game of chance. The appearance of spinning can be achieved by, for example, applying pulses to the motor 112 at time intervals appropriate to cause the reel 114 to accelerate, spin at constant speed, or decelerate.

The rotational speed, acceleration, and deceleration of a stepper motor can be specified as a list or sequence of time durations that are to elapse between consecutive steps. A motor controller 108, also referred to herein as a motion controller or motion control logic, applies pulses to the motor 112 via the motor interface 110 in accordance with the sequence of time durations specified by the motion control profile 104 by applying a first pulse of electricity, waiting for a period of time that corresponds to the first time duration in the sequence, applying a second pulse, waiting for a period of time that corresponds to the second duration, and so on, for each time duration in the sequence. Because each step of the motor is a fraction of a 360° turn, a full 360° turn can involve hundreds of pulses, and a single “spin” of the reel 114 (from start to end of rotation) may be achieved by applying thousands of pulses, each of which causes the stepper motor 112 to rotate by one step. For example, in the Wheel of Fortune® slot machine game, from the point at which a wheel 114 begins to decelerate from full speed to the point at which the wheel stops, the motor controller 108 issues 1200 pulses, each with sub-millisecond accuracy.

Stepper motors 112 and other motion-generating devices can be activated by motor controllers 108 or other types of motion controllers. Motion controllers can be implemented as, for example, integrated circuits or microprocessors executing computer program code, which cause electrical pulses to be applied to the motors or devices via the motor interface 110.

A motion control profile 104 can be understood more generally as a set of data and/or instructions that describe a motion (e.g., rotation, shaking, vibration, a rubber band effect, or other type of movement) of a component in an electronic gaming machine A particular motion, such as a spin of a single reel from start to end of rotation, can be described by a single profile, or by a composite profile that includes a sequence of smaller profiles describing corresponding portions of the motion (e.g., acceleration, constant speed, deceleration, and the like). The motion described by the composite profile can be generated by processing each of the smaller profiles in the sequence consecutively.

The motion controller illustrated in FIG. 1 can be an electronic circuit located on the main processor board or master gaming controller (not shown) of an electronic gaming machine 100. A motion control profile 104 resides in a memory 102, e.g., a random access memory (“RAM”), flash memory, read-only memory (“ROM”), or the like, which is located on the main processor board. The motion controller can alternatively be located on a secondary circuit board dedicated to controlling the motor, in which case the motion control profile 104 resides in a memory of the secondary board. Such configurations are used, for example, in IGT gaming machines based on the Intel 80960 processor. However, if new game firmware is installed on the main processor board, the new game firmware is ordinarily restricted to using the same motion control profiles as the previous game firmware, because the motion control profile(s) stored on the secondary board have not changed. If the profiles on the secondary board are to be changed, for example, to modify the reel rotation for the new game, then a new set of motion control firmware for the secondary board will be needed, and regulatory approval will have to be obtained for both the new motion control firmware and the new game firmware. As obtaining such approval can involve substantial time and effort, it would be desirable to develop motion control systems that are more flexible and can more easily gain regulatory approval.

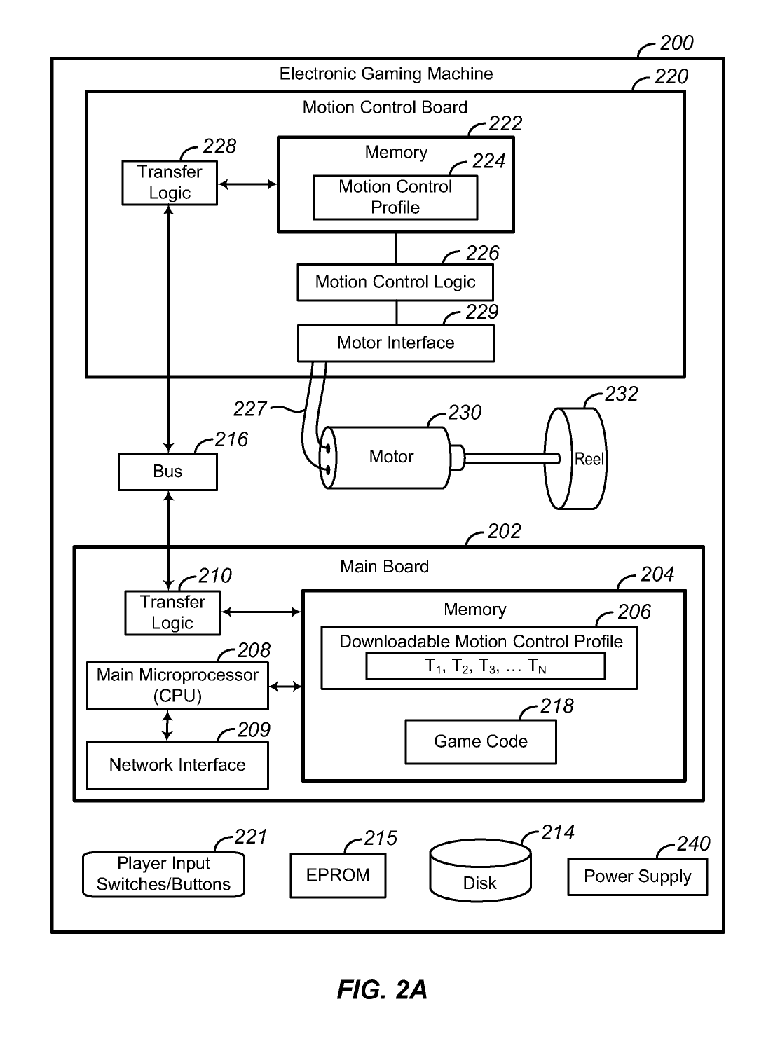

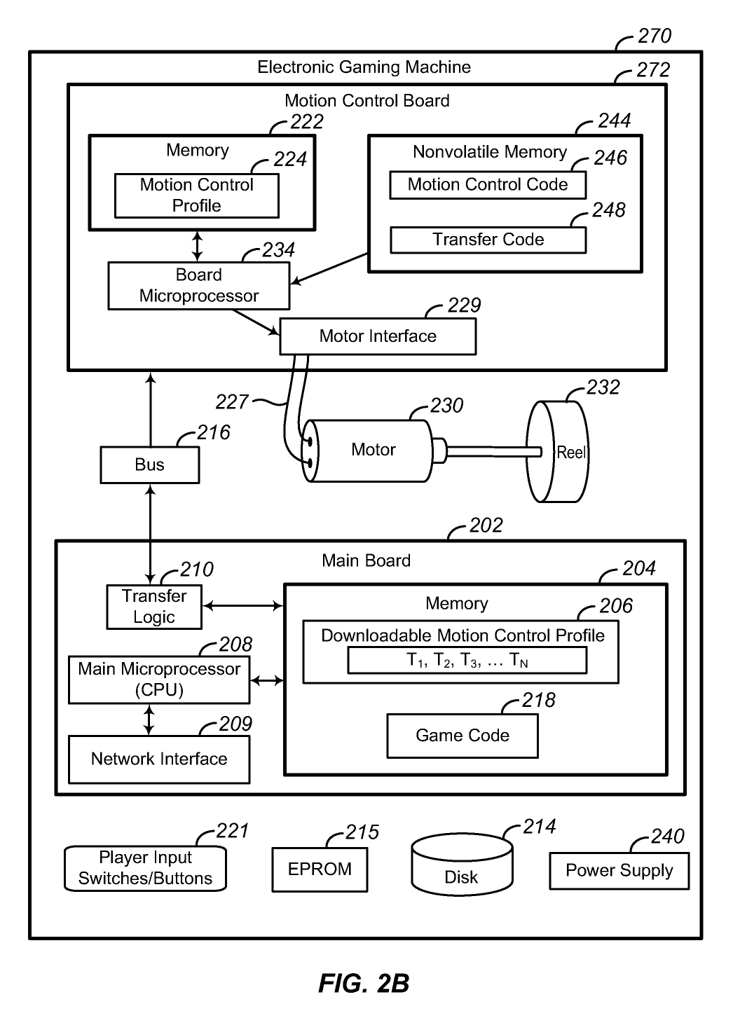

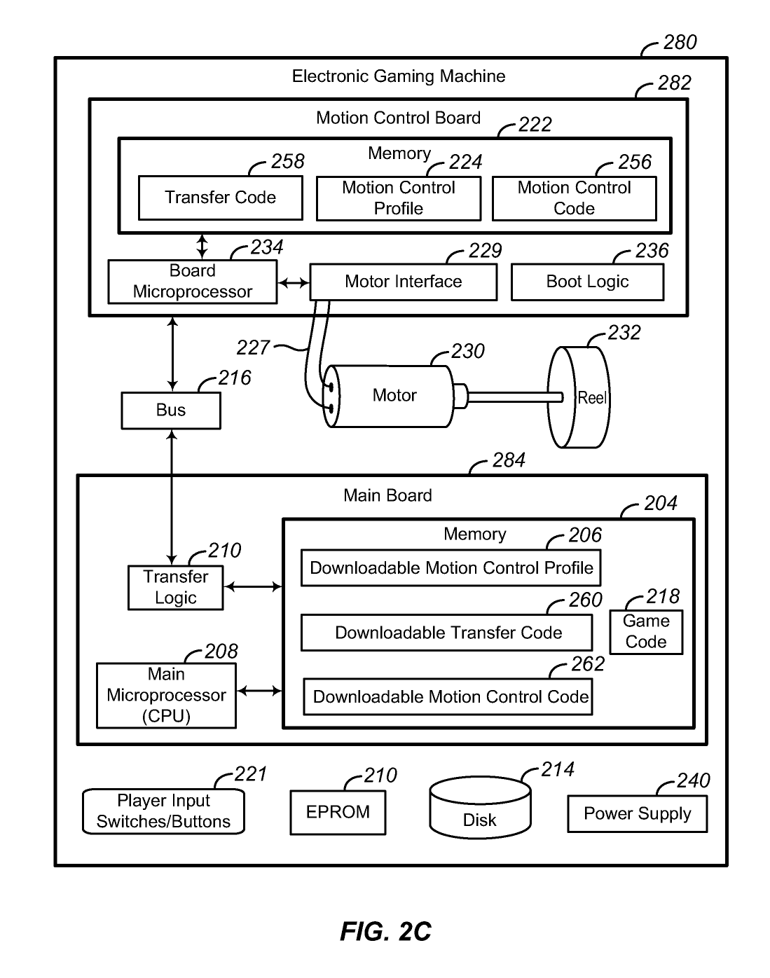

FIG. 2A illustrates an electronic gaming machine and motion control board implemented using logic components in accordance with embodiments of the invention. An electronic gaming machine (“EGM”) 200 includes, without limitation, a mainboard 202 (e.g., a motherboard), a motion control board 220, an interface bus 216, one or more stepper motors 230, one or more reels 232 coupled to the motor(s) so that the reel(s) rotate when the motor is activated, one or more player input switches 221, e.g., Spin buttons 221, a non-volatile memory device such as an EPROM 215, and/or a volatile mass storage device such as a disk drive 214, and a power supply 240. The bus 216 provides an interface for transferring data between at least the mainboard 202 and the motion control board 220 and is, for example, a Universal Serial Bus (USB) bus, a PCI bus, or other interface bus capable of transferring data. In other embodiments, wheels or other movable components can be present in addition to or instead of the reels 232. Each of the reel(s) 232 is coupled to a shaft of stepper motor(s) 230 such that rotation of the shaft by the motor 230 causes a corresponding rotation of the reel 232. References to rotation of the motor 230 herein should be understood to refer to rotation of the motor's shaft; the motor's housing does not ordinarily rotate.

The mainboard 202 can be a motherboard that operates as a master gaming controller, and has mounted thereon or is otherwise coupled to a memory 204, a main microprocessor (CPU) 208 that reads and writes data from and to the memory, mainboard transfer logic 210 that reads and writes data from and to the bus 216, and a network interface 209 that sends and receives data to and from a computer network (not shown). The memory 204 may be, for example, a random access memory (“RAM”) in which instructions, including game code 218, which implements a game of chance, and data, including one or more downloadable motion control profile(s) 206, are stored. The microprocessor 208 can be, for example, an AMD Turion™ processor, an Intel Core® processor, or the like.

The motion control board 220 can be a circuit board, a daughterboard, a PCI bus card, or other type of circuit board. The motion control board 220 includes a read/write memory 222, e.g., a RAM or flash memory, motion control logic 226, a motor interface 229, and motion control board transfer logic 228. The motion control logic 226 controls, i.e., activates and/or deactivates, the motor 230 by applying electrical pulses to the motor's terminals via wires 227, or by instructing the motor interface 229 to apply electrical pulses via the wires 227. In one example, the motor rotates when activated, e.g., by one fixed-size step for each electrical pulse in the case of a stepper motor, thereby causing the attached reel 232 to rotate. The motor interface 229 is optional, and, if not present, the motion control logic 226 can be connected to the motor 230. The motor interface 229 can be, for example, an amplifier that increases the magnitude of its input current, or, if the motor is driven by analog signals, a digital-to-analog converter.

Motion control logic 226 retrieves the motion control profile 224 from the memory and supplies current to the stepper motor 230 at times specified by the motion control profile 224. As introduced above, the stepper motor 230 rotates by a predetermined angular displacement each time a pulse of electric current is supplied to the motor 230. The source of the current may be, for example, a power supply 240. The acceleration, speed, and/or deceleration of the motor and the attached reel are determined by the particular sequence of times at which current is supplied to the motor 230. The characteristics of the motion that occurs when the motor 230 is activated are determined based upon the downloadable motion control profile(s) 206 as described in further detail below. The downloadable motion control profiles 206 are stored in the mainboard memory 204, from which they are transferred to the motion control board 220. Upon being transferred to the motion control board 220, the motion control profiles 206 are referred to herein as downloaded motion control profiles 224 for illustrative purposes, because they are stored in the memory 222 of the motion control board 220. However, the contents of the downloadable motion control profiles 206 and the downloaded motion control profiles 224 are ordinarily the same, and the term “motion control profiles” is used herein when referring to common properties of both profiles 206, 224. The downloaded motion control profiles 224 are accessed in the memory 222 by the motion control logic 226 to control the motion of the motor 230.

In one example, each motion control profile 206, 224 includes data that describes particular movement patterns of movable components such as reel(s) 232 coupled to the EGM 200. A motion control profile 206, 224 is represented as, for example, a list of time values that specify time durations between consecutive steps of the stepper motor, e.g., between consecutive pulses of power. The motion control profiles 206, 224 each include a list of time values T₁, T₂, T₃ through T_{N}, where N is the number of time values in the list. Each time value represents a duration or period of time that is to elapse between successive activations of the stepper motor 230. As an example, a motion control profile “32, 146, 18, 68” has four time duration values and specifies that there is to be a delay of 32 μs before the next pulse is issued to the motor, then a delay of 146 μs before the pulse after that, and so on. The motion control profiles 206, 224 may be stored in memory as, e.g., an array, a list, a lookup table structure, or any other suitable data format. The list of time values defines the rotational acceleration, speed, and deceleration of the motor. Decreasing the time values between consecutive pulses produces rotational acceleration, and increasing the time values produces deceleration.

In one example, the mainboard transfer logic 210 transfers the downloadable motion control profile(s) 206 to the motion control board memory 222. This transfer operation can be implemented as, for example, a memory copy operation that copies data from the memory location of the motion control profile 206 in the main memory 204 to a destination memory location in the motion control board memory 222. That destination memory location thus becomes the location of the downloaded motion control profile 224, from which location the motion control logic 226 can access the downloaded profile 224. The CPU 208 can perform the memory copy operation by reading the data bytes that represent the downloadable motion control profile 206 from the main memory 204 and storing those bytes in the board memory 222 starting at the destination memory location. Copying the data to the motion control board 220 can be implemented using an interface bus 216, e.g., USB, PCI, or the like. The CPU 208 can read the data from the main memory 204, and mainboard transfer logic 210 can transmit the data via the bus 216 to the motion control board 220. The motion control board transfer logic 228 receives the data from the bus 216 and stores the data in the memory 222 starting at the destination memory location. The destination memory location can be determined by, for example, the CPU 208 in combination with program code, the mainboard transfer logic 210, or the motion control board transfer logic 228, in accordance with the details of a particular implementation. The result of that copy operation is a downloaded motion control profile 224 in the board memory 222, such that the in-memory representation of the downloaded motion control profile 224 includes the same contents (e.g., byte values) as the in-memory representation of the source downloadable motion control profile 206.

Although transferring the motion control profile to the board memory 222 has been described as producing a copy of the contents of the downloadable motion control profile 206 from the main memory 204, the transfer may also include a transformation of the downloadable motion control profile contents, e.g., a transformation that converts the profile contents based upon the type of motor 230 (or other motion-generating device) present in the gaming machine For example, the transfer may include transforming the downloadable profile 206 based upon the type of game implemented by the game code, e.g., to compress or expand the motion in time, or to increase or decrease the profile's total time duration by truncation or repetition of all or a portion of the profile, respectively, as may be appropriate for a particular game, player, or gaming establishment.

Multiple motion control profiles 206, 224 can be stored in the memories 204, 222 so that, for example, different profiles can be used to produce different types of motion without transferring a profile for each activation of the motor 230, as described in more detail below. Motion control profiles are not limited to lists of time values, and can include other types of data, such as electrical current values for analog motion generating devices, commands in a motion control language, such as instructions to move or rotate by a specified distance or frequency, conditional instructions to define behavior conditional on specified data values, and flow control instructions to create loops.

The motor 230 or other motion generating device rotates or moves in accordance with the motion control profiles 206 when, for example, game-related events occur, such as initialization of the EGM, a player supplying input, e.g., by pressing a spin button 221, or receipt of new or updated game logic, motion control logic, or motion control profiles from a server via a server-based network, or an instruction to spin the reel (e.g., as a result of the game code 218 invoking a function to spin the reel). In one example, downloadable motion control profiles 206 can be transferred to the motion control board memory 222 prior to an initial movement of the motion generating device 230. In another example, the downloadable profiles 206 can be transferred prior to each use of a downloaded motion control profile 224 to control the motion generating device 230, so that the downloaded motion control profile 224 can be updated prior to each movement of the device 230. As introduced above, the motion control profile 224 can also be transferred in response to a game-related event such as the initialization of a game, a player pressing a Spin button 221, a start of a new game, a change in game play in the game in progress, a command received from a remote computer or server the network, a time-based event, a random event, or any other event for which changing the motion of the reel(s) 232 is desired.

The logic components shown in FIG. 2A, such as the motion control logic 226 and the motion control board transfer logic 228, can be implemented as, for example, integrated circuits. Either one or both of the mainboard transfer logic 210 and the motion control board transfer logic 228 can be present in the EGM 200, depending upon the details and board component capabilities of a particular implementation.

FIG. 2B is a block diagram that illustrates a motion control board implemented using a microprocessor and program code in accordance with embodiments of the invention. The logic components introduced above with respect to FIG. 2A can be implemented using a microprocessor programmed with computer program code, as shown in FIG. 2B. For microprocessor code implementations, the motion control board 220 can include a board microprocessor 234 for executing computer program code instructions that implement the motion control logic 226 and cause the motor 230 to rotate in accordance with the motion control profile(s) 224. The board microprocessor 234 can be of a type different from the mainboard microprocessor 208. The board microprocessor 234 can execute motion control board transfer logic 228 to transfer motion control profiles 206 from the mainboard memory 204 to the motion control board memory 222 via the bus 216.

An electronic gaming machine (“EGM”) 270 of FIG. 2B includes the features described above with respect to FIG. 2A, except the motion control board 220 of FIG. 2A is replaced with a microprocessor-based motion control board 272 in FIG. 2B. The motion control board 272 of FIG. 2B includes the board microprocessor 234 that can be programmed with computer program code that resides in a nonvolatile memory 244. The nonvolatile memory 244 may be, for example, a read-only memory (ROM), or a writable and rewritable memory (NVRAM), e.g., a flash memory, a magnetic storage device such as a disk, or other type of persistent data storage device. The motion control board 272 communicates with the mainboard 202 via the bus 216, as described above with reference to FIG. 2A. The ROM/NVRAM 244 located on the motion control board 272 contains motion control code 246 and transfer code 248, which are computer program code implementations of the motion control logic 226 and motion control board transfer logic 228, respectively, of FIG. 2A. The board microprocessor 234 executes the computer program code 246, 248 by loading the code instructions directly from the ROM/NVRAM 244, or by copying the code from the ROM/NVRAM 244 into the memory 222 and then loading the code instructions from the memory 222. The microprocessor 234 can execute the transfer code 248 to transfer and receive the motion control profile(s) 224 from the mainboard 202. Furthermore, the microprocessor 234 can execute the motion control code 246 to operate the motor 230 via the motor interface 229 in accordance with the received motion control profile(s) 224, to cause the motor to produce the motion described in the motion control profile(s) 224. The code 246, 248 can be programmed into the ROM/NVRAM 244 when, for example, the EGM 270 is manufactured or serviced, or loaded into the ROM/NVRAM 244 at some other time, e.g., during a download of software updates from a server.

FIG. 2C illustrates a motion control board 282 implemented using a microprocessor 234 and computer program code loaded from a mainboard 284 in accordance with embodiments of the invention. The motion control board 282 controls the motor 230 using a downloaded motion control profile 224 as described above with reference to FIG. 2B, but downloaded transfer code 258 and downloaded motion control code 256 are transferred from the mainboard 284 in the example of FIG. 2C instead of being initially present on the motion control board 282. Boot logic 236 located on the motion control board 282 downloads program code from the memory 204 of the mainboard 284 to control a stepper motor 230 in accordance with embodiments of the invention. The program code loaded by the boot logic 236 can include the downloadable transfer code 258 and/or downloaded motion control code 256, which can be transferred from the main memory 204 via the bus 216 to the board memory 222 to form the downloaded transfer code 258 and/or downloaded motion control code 256, respectively. The transfer code 258 can itself cause transfer of downloadable motion control profiles 206 and/or the downloadable motion control code 256 from the main memory 204 via the bus 216 and to the board memory 222 starting at the destination memory location, to form the downloaded motion control profiles 224 and/or the downloaded motion control code 256, respectively.

When executed by the board microprocessor 234, the motion control code 256 retrieves the downloaded motion control profile 224 from the board memory 222 and causes the motor interface 229 to supply electric current to the stepper motor 230 in accordance with the downloaded motion control profile 224. The acceleration, speed, and/or deceleration of the motor and the attached reel 232 are determined by the motion control profile 224, which specifies time intervals between successive applications of electric current to the stepper motor 230 by the motor interface 229. The downloadable transfer code 260 and the downloadable motion control code 262 can be initially loaded into the main memory 204 from, for example, an EPROM 210, a disk 214, or a network server via a network interface (not shown) when the EGM 280 is initialized or reset, or when a new game is loaded, or when the downloadable code 260, 262 is transmitted to the EGM from a server via the network. Then, the downloadable code 260, 262 can be transferred from the mainboard memory 204 into the motion control board memory 222 via the bus 216 by instructions executed by the main microprocessor 208, e.g., the transfer code 260, to transfer the motion control code 262, or by instructions executed by the motion control board microprocessor 234, e.g., the boot logic 236 or the transfer code 258.

In one implementation, when the EGM 280 boots up, e.g., begins to operate or is restarted by a reset command, the motion control board memory 222 does not contain the transfer code 258, the motion control code 256, or the motion control profile 224. Instead, the boot logic 236, which can be, for example, program code stored in a non-volatile memory such as a ROM or flash memory, is executed by the board microprocessor 234 when the EGM boots up or is restarted after being reset. The boot logic 236 checks the memory 222 for instructions and/or information about the hardware installed on the motion control board 282. If instructions are present, the boot logic 236 transfers control to the instructions. Thus, if the transfer code 258 and motion control code 256 are already present in the memory 222, e.g., after a soft reset, the boot logic 236 instructs the board microprocessor 234 to execute the transfer code 258 and motion control code 256. If no instructions are present in the memory 222, the boot logic 236 instructs the board microprocessor 234 to load instructions from the main memory 204 on the mainboard 284, thereby causing the downloadable transfer code 260 to be downloaded into the motion control board memory 222, in which the downloaded code is stored as the downloaded transfer code 258. The boot logic 236 then transfers control to the downloaded transfer code 258. In another implementation, the downloaded transfer code 258, the downloaded motion control code 256, and/or the downloaded the motion control profile 224 may be downloaded from a remote device via a network, such as from a server or from another gaming machine via a network protocol such as TCP/IP or via an sb™ network.

In one implementation, the board microprocessor 234 can execute the transfer code 258 to load the downloadable motion control profile(s) 206 from the main memory 204 into the board memory 222, via the bus 216, to form the downloaded motion control profile(s) 224 at appropriate times, e.g., in response to gaming events. In this example, the board microprocessor 234 is programmed to execute instructions that copy a data structure, e.g., a list of numbers, which represents the motion control profile 206, to the board memory 222. The copy of the data structure thereby created in the board memory 222 forms the board-resident motion control profile 224. The motion control board microprocessor 234 also executes motion control code 256 to operate the motor 230 in accordance with the motion control profile(s) 224. In one implementation, the motion control code 256 can authenticate the motion control profile 224 by, for example, computing a checksum or hash value of the motion control profile 224 and comparing the checksum or hash value to a known correct value, e.g., a value received from the memory 204. If the computed value and the known correct value match, then the motion control profile 224 is considered to be authentic and execution continues; otherwise, if the values are not equal, the motion control code 256 generates an error to prevent the EGM 280 from using the motion control profile 224.

In another example, the downloadable motion control code 262 can alternatively be stored in an EPROM 210 or other non-volatile memory located on the mainboard 284, and transferred to the motion control board memory 222 when, for example, the EGM is initialized or reset, as described above. The transfer code 258 can authenticate the motion control code 256 by, for example, computing a checksum or hash value of the motion control code 256 and comparing the checksum or hash value to a known correct value. If the computed value and the known correct value match, then the motion control code 256 is considered to be authentic and execution continues; otherwise, if the values are not equal, the transfer code 258 generates an error to prevent the EGM 280 from using the motion control code 256.

As introduced above, the motion control profile 206 can be copied to the motion control board 282 in response to a variety of different events, with particular types of events being determined by, for example, a game implementation, a gaming machine operating system, or an operator's preferences. A game implemented by the game code 218, such as a slot machine game, can have multiple modes of play, e.g., a normal mode and a frenzy mode. In the normal mode, the game causes the reel(s) and/or wheel(s) 232 to spin using acceleration and deceleration profiles that produce an appearance of the reels spinning at an average or medium speed. In the frenzy mode the reels spin faster and reverse directions several times to indicate a variation on the game, such as a bonus mode. The game program can thus define a normal motion control profile and a frenzied motion control profile, and load these profiles into the motion control board memory 222 at the appropriate time(s) to cause the reels to spin accordingly. In another example, the game operating system can provide an application programming interface (“API”) for use by game programs to cause the motion control profiles to be loaded at particular points during the game's execution. In one example, this programming interface may include a single function that loads a given motion control profile into the motion control board's memory 222, so that the most recently loaded motion control profile 224 will be used when the reels spin.

The aforementioned programming interface may include a computer code function that loads a motion control profile 224 in association with an identifier such as a profile number, so that multiple profiles can be loaded into the memory 222 at different memory locations, and the game can select a particular profile to be used at a particular time, e.g., by invoking an interface function that selects the profile associated with a specified label identifier for use in subsequent spins. The selected profile will be used by default until a different profile is selected by another invocation of the interface function.

As an example, a “download profile” interface function may be provided to allow a game program to transfer specified downloadable motion control profiles 206 to the motion control board 282. Accordingly, a program code function with a name such as “DownloadProfile” can be provided to cause a given profile to be downloaded to the motion control board 282. A variation of the DownloadProfile function can be provided to cause a given profile to be downloaded to the motion control board and associated with a given label, so that the downloaded motion control profile 224 can subsequently be selected by a “select profile” function to which the label is provided by the game code. If a gaming machine has multiple motion-generating devices, another variation of the DownloadProfile function can be provided, in which a device identifier and a particular motion control profile 224 are supplied, and the function causes the particular motion control profile 224 to be downloaded and associated with the identified device, so that subsequent activations of the identified device, such as a spin of a reel or wheel component, will automatically use the associated motion control profile 224. For example, a first motion control profile can be associated with an individual reel, and second and third motion control profiles can be associated with second and third individual reels. When the reels spin, each reel spins in accordance with its associated profile.

When storing a motion control profile 224 in association with a label or a device identifier, the profile can be stored in the memory 222 as a value in a lookup table, with an associated lookup key based on the label or device identifier, so that the motion control profile 224 can be retrieved from memory based upon the label or identifier. A “select profile” interface function may be provided to allow selection of a previously-downloaded profile 224, where the profile is identified by the previously-associated label. These profiles 224 can be either acceleration or deceleration profiles. In another example, a deceleration profile can be generated automatically by reversing an acceleration profile 224.

In accordance with embodiments of the invention, the board-resident motion control profile(s) 224 can advantageously be changed (e.g., by the mainboard's microprocessor) without changing the motion control board's motion control logic 256. Furthermore, changing the motion control profile(s) 224 does not require submitting a new set of motion control board firmware for regulatory approval with the new mainboard game firmware, as would be necessary when motion control profiles are embedded or permanently stored on the motion control board 282.

In another example, multiple electronic gaming machines can be linked together via a computer network, and a server computer can communicate with the EGM's via the network. In such a network configuration the server computer may transmit one or more motion control profiles to the EGMs, and each EGM can then download the motion control profiles to a motion control board in the EGM via the network interface 209. The transmission of the motion control profiles to the EGMs can occur in a coordinated or synchronized event so that the EGM's download motion control profiles before any game begins operation.

In one aspect, the motion control profiles 206 can be validated or tested before being downloaded to a motion control board 282. Such validation can include checking that the motion control profile correctly produces the motion expected by the game designer. Motion control profiles that are specified as a sequence of time durations generate essentially the same motion each time they are used by the motion control logic, so a motion control profile can be verified to be within the performance capabilities of the motion generating device and the EGM by testing the profile's sequence of time durations on the EGM. Such testing can provide a strong assurance that the motion control profiles correctly express the desired physical motions.

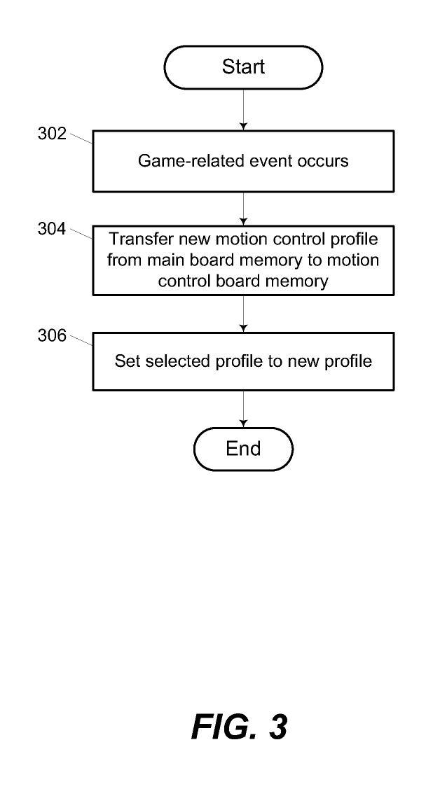

FIG. 3 is a flow diagram of a motion control profile transfer process in accordance with embodiments of the invention. The transfer process corresponds to, for example, the mainboard transfer logic 210 and the motion control board transfer logic 228 of FIG. 2A, mainboard transfer logic 210 and the transfer code 258 of FIG. 2C, and may be implemented by a microprocessor programmed with computer code in accordance with the flow diagram. The transfer process can be invoked in response to a gaming event such as initialization of the EGM, a player supplying input, e.g., by pressing a spin button 221, or receipt of new or updated game logic, motion control logic, or motion control profiles from a server via a server-based network. The transfer process can also be invoked by game logic or other code executing on the CPU 208 when such code explicitly requests a transfer of a motion control profile, e.g., by invoking the DownloadProfile function described above. Block 302 represents an occurrence of such an event. Block 304 transfers a downloadable motion control profile 206 from the mainboard memory 204 to the motion control board memory 222, thereby forming the downloaded motion control profile 224. The transfer operation can be implemented by, for example, requesting a data transfer on the bus 216 from the address of the downloadable motion control profile 206 in the main memory 204 to the target address of the downloaded board-resident motion control profile 224 in the board memory 222. The quantity of data (e.g., number of bytes) to be transferred is based upon the size of the data that represents the motion control profile 206. At block 306, the motion control profile most recently transferred becomes the currently-selected profile of the motion control board 220. The currently-selected profile determines the motion of the motor 230 for each activation of the motor until another motion control profile is transferred (e.g., by an invocation of the DownloadProfile function described above) or explicitly selected (e.g., by an invocation of the SelectProfile API function).

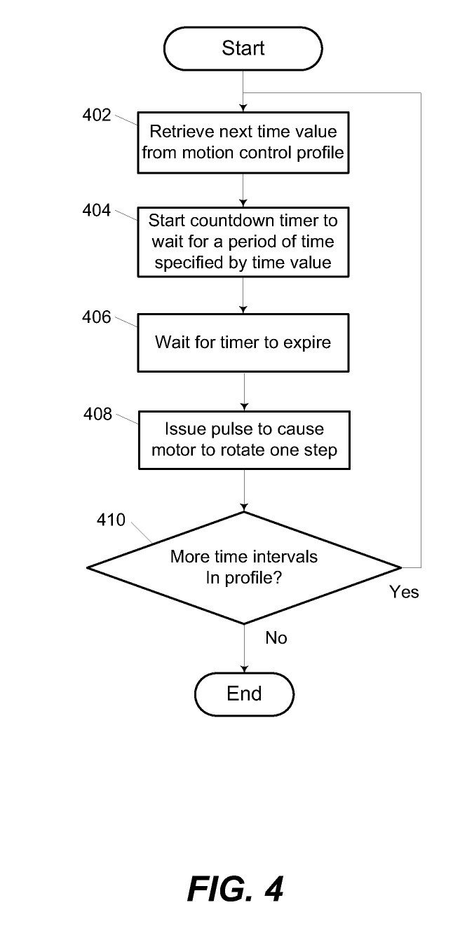

FIG. 4 is a flow diagram of a motion control process in accordance with embodiments of the invention. The motion control process corresponds to the motion control logic 226 of FIG. 2A, or the motion control code 246 of FIG. 2B, or the motion control code 256 of FIG. 2C, and may be implemented by a microprocessor programmed with computer program code. The motion control process begins at block 402 by accessing a downloaded motion control profile 224 stored in the memory 222 and retrieving a time value or other motion specifier from the motion control profile 224. Block 404 starts a countdown timer initialized to the retrieved time value, and block 406 waits for a time interval based upon the period of time specified by the retrieved time value. Block 408 issues a pulse to the motor 230 to cause a unit of motion, e.g., rotation by one step in the case of a stepper motor. Block 410 determines if there is at least one more time interval in the profile 224 following the time interval previously retrieved at block 402. If so, block 410 transfers control to block 402, which retrieves the next time interval from the profile 224. If all valid time intervals in the profile 224 have been processed, the motion control process ends.

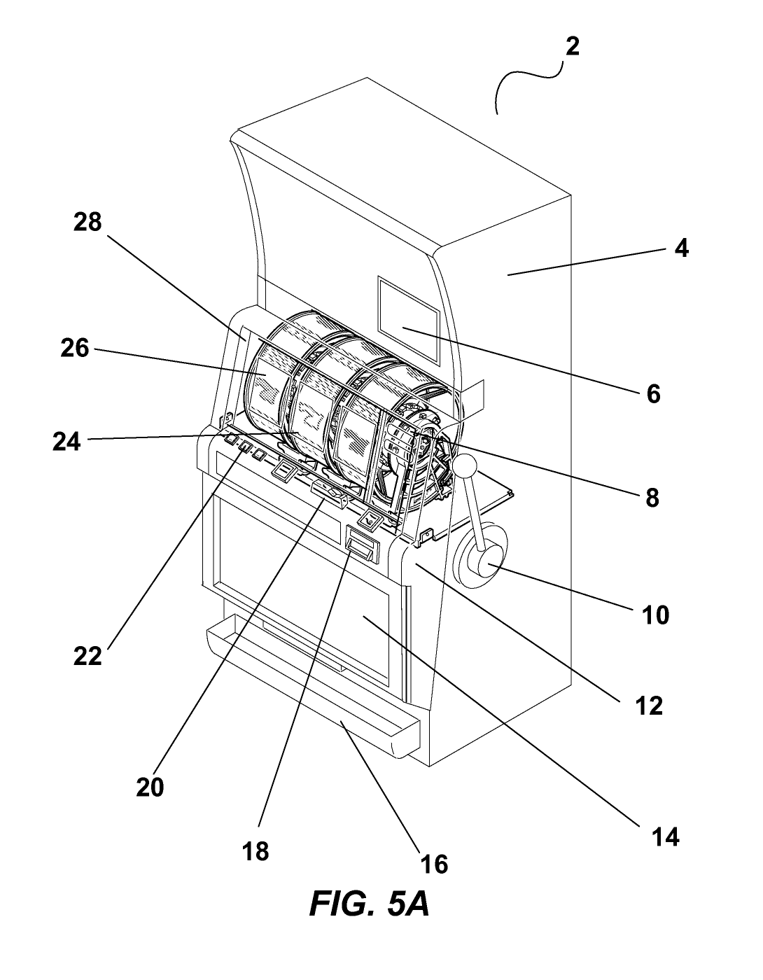

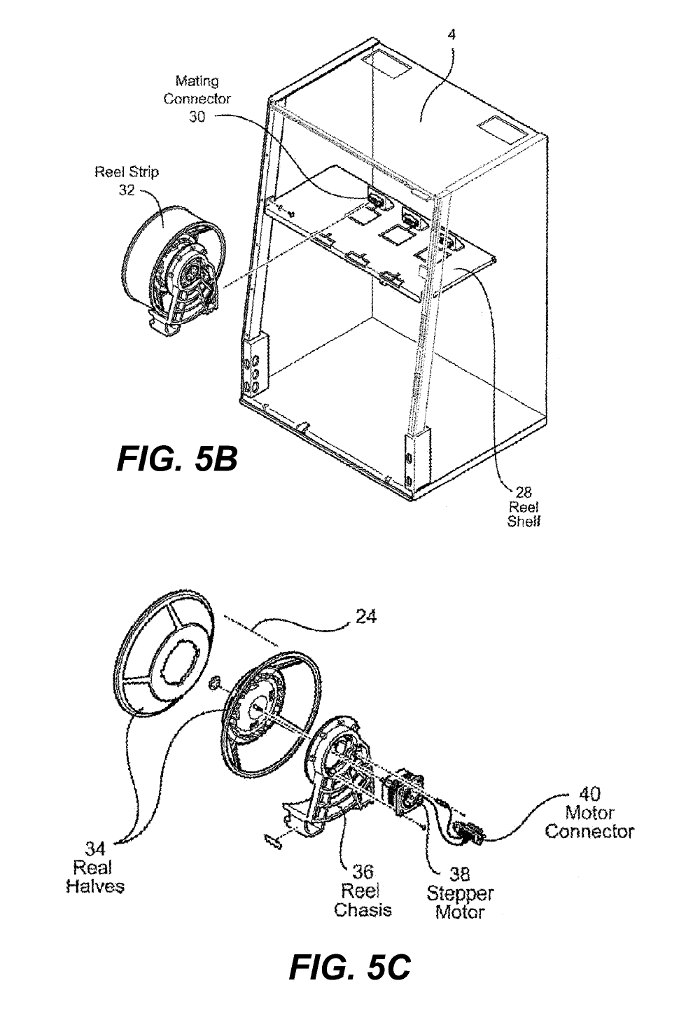

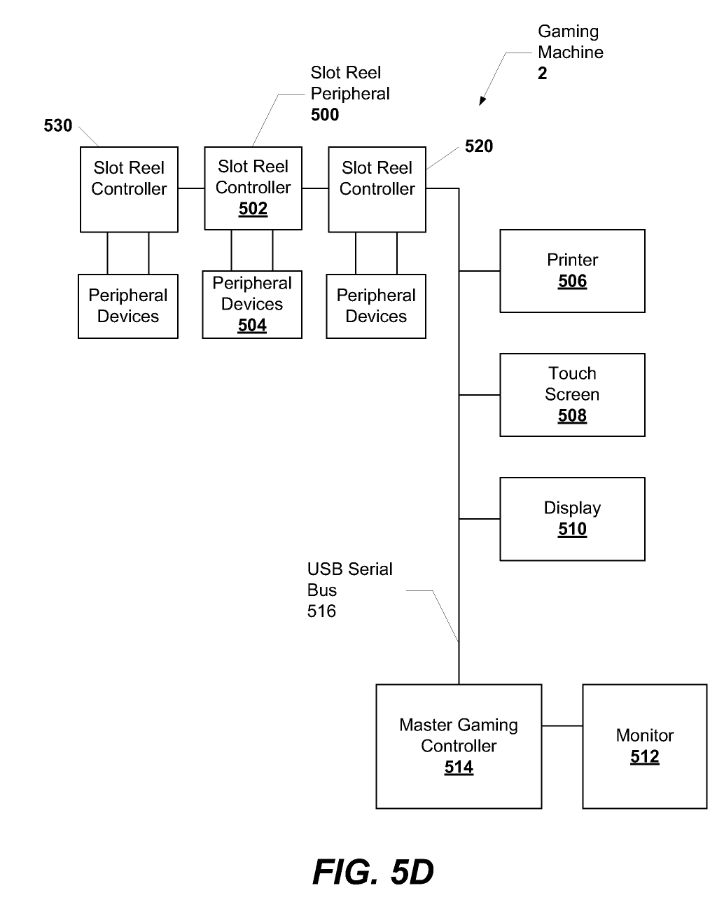

Turning next to FIG. 5A, a gaming machine 2 that may be used in accordance with the present invention is shown. The gaming machine 2 includes a main cabinet 4, which generally surrounds the machine interior (not shown) and is viewable by users. The main cabinet includes a main door 12 on the front of the machine, which opens to provide access to the interior of the machine. Typically, the main door 12 and/or any other portals which provide access to the interior of the machine utilize a locking mechanism of some sort as a security feature to limit access to the interior of the gaming machine. Attached to the main door are player-input switches 22, a coin acceptor 20, and a bill validator 18, a coin tray 16, and a belly glass 14. Viewable through the main door is three slot reel assemblies 24. Each slot reel assembly is covered with a reel strip 32. The reel strip 32 is covered with various symbols that are displayed during the course of a game being played on the slot machine. The reel assemblies are behind a display panel 26 of some type. Above the main door is a video display monitor 6. The display monitor 6 will typically be a cathode ray tube, high resolution flat-panel LCD, or other conventional electronically controlled video monitor. The display monitor may add additional features to the game being played on the slot machine. Next to the reel assemblies is an information panel 8. The information panel 8 is a back-lit, silk screened glass panel with lettering to indicate general game information including, for example, the number of coins played. On the side of the gaming machine is a slot reel handle 10. The slot reel handle 10 may be used by a player to activate the slot reels 24 during the course of a game. The bill validator 18, player-input switches 22, video display monitor 6, slot reel handle 10 and information panel 8 are devices used to play a game on the gaming machine 2. The devices are controlled by circuitry (not shown) housed inside the main cabinet 4 of the machine 2. Many possible types of slot machine games may be provided with gaming machines of this invention.

When a user wishes to play the gaming machine 2, he or she inserts cash through the coin acceptor 20 or bill validator 18. At the start of the game, the player may initiate game play by pulling the slot reel handle 10 on the side of the gaming machine or by pressing one of the player input switches 22. During the game, the player may view additional game information and be presented with additional game options using the video display 6. Usually, during the course of a game, a player is required to make a number of decisions, which affect the outcome of the game. The player makes these choices using the player-input switches 22. During certain game events, the gaming machine 2 may display visual and auditory effects that can be perceived by the player. These effects add to the excitement of a game, which makes a player more likely to continue playing. Auditory effects include various sounds that are projected by the speakers (not shown). Visual effects include flashing lights, strobing lights or other patterns displayed from lights on the gaming machine 2 including lights behind the belly glass 14, from patterns on the video display 6, or from lights on the reel assemblies 24. After the player has completed a game, the player may receive game tokens from the coin tray 16 which may be used for further games.

FIG. 5B is a perspective drawing of a gaming machine cabinet and slot reel assembly. The main cabinet 4 contains a reel shelf 28 which usually supports three reel assemblies 24. The reel assembly 24 contains a reel strip 32. The reel strip 32 will usually be covered with a number of symbols which are utilized during the game play. Each reel assembly 24 is usually plugged into a mating connector 30. The mating connector usually contains connections to a power source needed to operate the reel assembly 24 and communication connections to circuitry (not shown) housed within the main cabinet 4 of the machine 2. During a game, the reel assembly and its associated devices may be controlled, in part, by the circuitry within the main cabinet of the gaming machine and by peripheral control circuitry (not shown) located within the reel assembly.

FIG. 5C is an exploded perspective drawing of the interior parts of a slot reel assembly. The reel is composed of two reel halves 34. The reel strip 32 is placed around the edges of the reel halves. The moment of inertia of the reel halves—which is a function of parameters including their diameter, shape, and material composition—is an important operational parameter of the reel assembly 24. The reel halves are supported by a reel chassis 36 which may be mounted to the reel shelf 28 shown in FIG. 5B. Before a player initiates a game, each reel assembly is usually motionless with each symbol on the reel strip in some initial position. When the player initiates a game, the each reel may be set in a rotating motion by a stepper motor 38 mounted on the reel chassis 36 and connected to the reel halves 34. The stepper motor 38 accelerates the reel halves 34 to a certain angular velocity and then stops the reel halves at some predetermined position. The position of the reel strip on each of the reel assemblies 24 may determine the outcome of the game initiated by the player.

FIG. 5D is a block diagram depicting a slot reel gaming peripheral and its connection over a communication network to a master gaming controller in accordance with embodiments of the invention. When a gaming machine 2 is operating, the master gaming controller 514 may communicate with a variety of gaming devices. This communication may be carried out using some type of standard communication protocol including a USB serial bus using a standard connection system 516.

During a game, the master gaming controller 514 may control devices including a monitor printer 506, a touch screen 508, a display 510, a monitor 512, or a slot reel peripheral 500. Using the standard communication connections and the standard communication protocol, the master gaming controller 514 may send instructions to a device to perform a specific operation. These instructions may be in the form of low-level or high-level instructions. The master gaming controller 514 sends low-level instructions to devices that it directly controls. Examples of low-level instructions might include turning on a specific light, turning off a specific light, starting a motor, or stopping a motor. The master gaming controller may send high-level instructions to the slot reel peripheral 500 (e.g., stop at the lemon symbol). The slot reel peripheral 500 is a device that contains, for example, a standard communication connection, a peripheral or slot reel controller 502, and connections to one or more peripheral devices on the slot reel. The slot reel controller 502 contains a microprocessor which may enable it to directly perform some operations based on the high-level instructions from the master gaming controller 514. Typically, the slot reel controller 502 controls one or more peripheral devices on the slot reel 504. For example the slot reel controller might control the stepper motor shown in FIG. 5C. Further, the slot reel peripheral 500 may be configured to control other reel peripherals including the slot reel peripherals 520 and 530 so that the three slot reel peripherals may operate as one unit when receiving commands from the master gaming controller 514. Also, when the communication connections and the standard communication protocol are used, the slot reel controller 504 enables communication between the master gaming controller 514 and one or more peripheral devices on the slot reel 504.

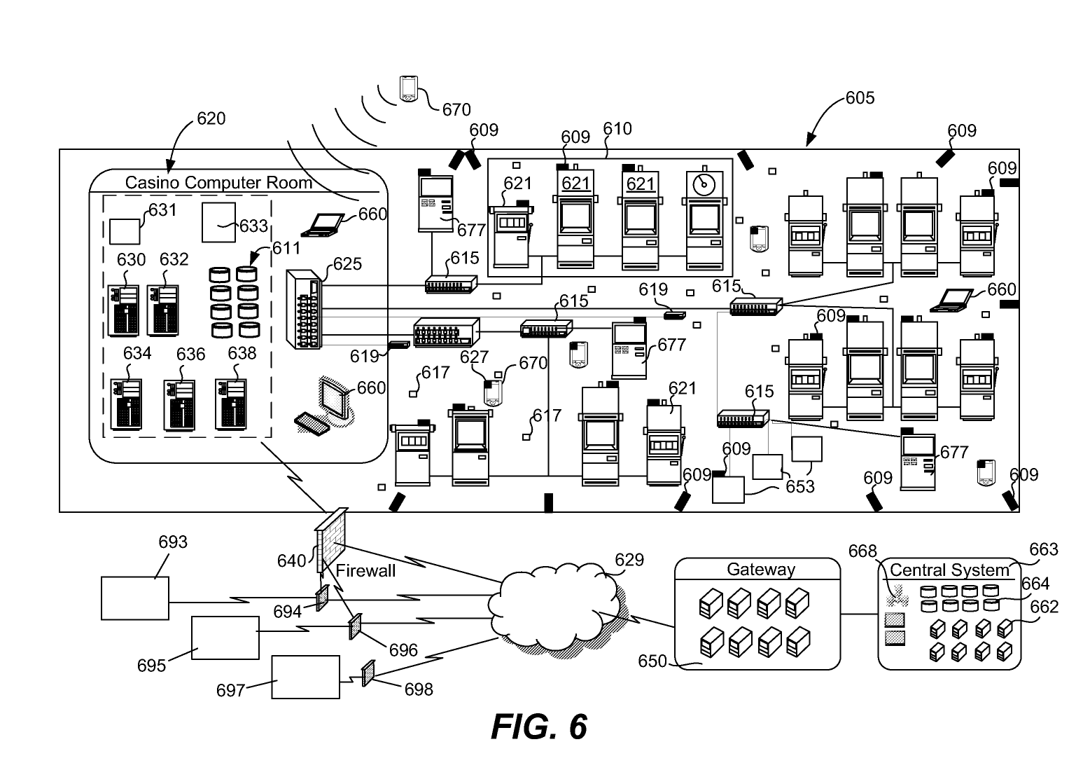

One example of an sb™ network is depicted in FIG. 6. Those of skill in the art will realize that this architecture and the related functionality are merely examples and that the present invention encompasses many other such embodiments and methods.

Here, casino computer room 620 and networked devices of a gaming establishment 605 are illustrated. Gaming establishment 605 is configured for communication with central system 663 via gateway 650. Gaming establishments 693 and 695 are also configured for communication with central system 663.

In some implementations, gaming establishments may be configured for communication with one another. In this example, gaming establishments 693 and 695 are configured for communication with casino computer room 620. Such a configuration may allow devices and/or operators in casino 605 to communicate with and/or control devices in other casinos. In some such implementations, a server in computer room 620 may control devices in casino 605 and devices in other gaming establishments. Conversely, devices and/or operators in another gaming establishment may communicate with and/or control devices in casino 605.

For example, a server of casino 605 or central system 663 may be provisioned with relatively more advanced software (e.g., 3-D facial recognition software) for patron identification than servers of other networked locations. Such a server may process patron identification requests from devices in casino 605 as well as patron identification requests from devices in gaming establishments 693 and 695.

Here, gaming establishment 697 is configured for communication with central system 663, but is not configured for communication with other gaming establishments. Some gaming establishments (not shown) may not be in communication with other gaming establishments or with a central system. Gaming establishment 605 includes multiple gaming machines 621, each of which is part of a bank 610 of gaming machines 621. In this example, gaming establishment 605 also includes a bank of networked gaming tables 653. However, the present invention may be implemented in gaming establishments having any number of gaming machines, gaming tables, etc. It will be appreciated that many gaming establishments include hundreds or even thousands of gaming machines 621 and/or gaming tables 653, not all of which are necessarily included in a bank and some of which may not be connected to a network. At least some of gaming machines 621 and/or mobile devices 670 may be “thin clients” that are configured to perform client-side methods as described elsewhere herein.

Some gaming networks provide features for gaming tables that are similar to those provided for gaming machines, including but not limited to bonusing, player loyalty/player tracking and the use of cashless instruments. Relevant material is provided in U.S. patent application Ser. No. 11/154,833, entitled “CASHLESS INSTRUMENT BASED TABLE GAME PROMOTIONAL SYSTEM AND METHODOLOGY” and filed on Jun. 15, 2005 (attorney docket no. IGT1P035X3), U.S. Provisional Patent Application No. 60/858,046, entitled “AUTOMATED PLAYER DATA COLLECTION SYSTEM FOR TABLE GAME ENVIRONMENTS” and filed on Nov. 10, 2006 (attorney docket no. IGT1P061X5P), U.S. patent application Ser. No. 11/129,702, entitled “WIDE AREA TABLE GAMING MONITOR AND CONTROL SYSTEM” and filed on May 15, 2005 (attorney docket no. IGT1P115), U.S. patent application Ser. No. 11/425,998 entitled “PROGRESSIVE TABLE GAME BONUSING SYSTEMS AND METHODS”, filed Jun. 22, 2006 (attorney docket no. IGT1P238/P-1049) and U.S. patent application Ser. No. 11/225,299, entitled “UNIVERSAL CASINO BONUSING SYSTEMS AND METHODS” and filed on Sep. 12, 2005 (attorney docket no. IGT1P243), all of which are incorporated herein by reference. Accordingly, software related to such features may be provided and/or controlled, and related data may be obtained and/or provided, according to the present invention.

Some configurations can provide automated, multi-player roulette, blackjack, baccarat, and other table games. The table games may be conducted by a dealer and/or by using some form of automation, which may include an automated roulette wheel, an electronic representation of a dealer, etc. In some such implementations, devices such as cameras, radio frequency identification devices, etc., may be used to identify and/or track playing cards, chips, etc. Some of gaming tables 653 may be configured for communication with individual player terminals (not shown), which may be configured to accept bets, present an electronic representation of a dealer, indicate game outcomes, etc.

Some gaming networks include electronically configurable tables for playing table games. U.S. patent application Ser. No. 11/517,861, entitled “CASINO DISPLAY METHODS AND DEVICES” and filed on Sep. 7, 2006 (attorney docket no. IGT1P106X2), describes some such tables and is hereby incorporated by reference. An operator may select a desired game, such as a poker game or a blackjack game, and the table will be automatically configured with geometrical patterns, text, etc., which are appropriate for the desired table game. The desired type of table game may be selected by a control on the table itself or according to instructions received from, e.g., a server or a casino manager via a network interface.

Gaming establishment 605 also includes networked kiosks 677. Depending on the implementation, kiosks 677 may be used for various purposes, including but not limited to cashing out, prize redemption, redeeming points from a player loyalty program, redeeming “cashless” indicia such as bonus tickets, smart cards, etc. In some implementations, kiosks 677 may be used for obtaining information about the gaming establishment, e.g., regarding scheduled events (such as tournaments, entertainment, etc.), regarding a patron's location, etc. Software related to such features may be provided and/or controlled, and related data may be obtained and/or provided, according to the present invention. For example, in some implementations of the invention, kiosks 677 may be configured to receive information from a patron, e.g., by presenting graphical user interfaces.

In this example, each bank 610 has a corresponding switch 615, which may be a conventional bank switch in some implementations. Each switch 615 is configured for communication with one or more devices in computer room 620 via main network device 625, which combines switching and routing functionality in this example. Although various communication protocols may be used, some preferred implementations use the Gaming Standards Association's G2S Message Protocol. Other implementations may use IGT's open, Ethernet-based SuperSAS® protocol, which IGT makes available for downloading without charge. Still other protocols, including but not limited to Best of Breed (“BOB”), may be used to implement various aspects of the invention. IGT has also developed a gaming-industry-specific transport layer called CASH that rides on top of TCP/IP and offers additional functionality and security.

Here, gaming establishment 605 also includes an RFID network, implemented in part by RFID switches 619 and multiple RFID readers 617. An RFID network may be used, for example, to track objects (such as mobile gaming devices 670, which include RFID tags 627 in this example), patrons, etc., in the vicinity of gaming establishment 605. Some examples of how an RFID network may be used in a gaming establishment are set forth in U.S. patent application Ser. No. 11/655,496, entitled “DYNAMIC CASINO TRACKING AND OPTIMIZATION” and filed on Jan. 19, 2007 (Attorney Docket No. IGT1P082C1X1/P-713 CON CIP) and in U.S. patent application Ser. No. 11/599,241, entitled “DOWNLOADING UPON THE OCCURRENCE OF PREDETERMINED EVENTS” and filed on Nov. 13, 2006 (Attorney Docket No. IGT1P118C1X1/P-303 CON CIP), all of which are hereby incorporated by reference.

As noted elsewhere herein, some implementations of the invention may involve “smart” player loyalty instruments, such as player tracking cards, which include an RFID tag. Accordingly, the location of such RFID-enabled player loyalty instruments may be tracked via the RFID network. In this example, at least some of mobile devices 670 may include an RFID tag 627, which includes encoded identification information for the mobile device 670. Accordingly, the locations of such tagged mobile devices 670 may be tracked via the RFID network in gaming establishment 605. Other location-detection devices and systems, such as the global positioning system (“GPS”), may be used to monitor the location of people and/or devices in the vicinity of gaming establishment 605 or elsewhere.

Various alternative network topologies can be used to implement different aspects of the invention and/or to accommodate varying numbers of networked devices. For example, gaming establishments with large numbers of gaming machines 621 may require multiple instances of some network devices (e.g., of main network device 625, which combines switching and routing functionality in this example) and/or the inclusion of other network devices not shown in FIG. 6. Some implementations of the invention may include one or more middleware servers disposed between kiosks 677, RFID switches 619 and/or bank switches 615 and one or more devices in computer room 620 (e.g., a corresponding server). Such middleware servers can provide various useful functions, including but not limited to the filtering and/or aggregation of data received from switches, from individual gaming machines and from other devices. Some implementations of the invention include load-balancing methods and devices for managing network traffic.

Storage devices 611, sb™ server 630, License Manager 631, Arbiter 633, servers 632, 634, 636 and 638, host device(s) 660 and main network device 625 are disposed within computer room 620 of gaming establishment 605. In practice, more or fewer devices may be used. Depending on the implementation, some such devices may reside in gaming establishment 605 or elsewhere.

One or more devices in central system 663 may also be configured to perform, at least in part, tasks specific to the present invention. For example, one or more servers 662, arbiter 633, storage devices 664 and/or host devices 660 of central system 663 may be configured to implement the functions described in detail elsewhere herein. These functions may include, but are not limited to, processing requests for motion control profiles, providing (at least in part) motion control profiles to gaming machines, providing motion control code and transfer code to gaming machines, and so on.

One or more of the servers of computer room 620 may be configured with software for receiving a player's wager gaming notification parameters, determining when a wagering condition corresponds with the wager gaming notification parameters and/or providing a notification to the player when the wagering condition corresponds with the wager gaming notification parameters. Moreover, one or more of the servers may be configured to receive, process and/or provide image data from cameras 609, to provide navigation data to patrons (e.g., to indicate the location of and/or directions to a gaming table, a wager gaming machine, etc., associated with a wager gaming notification), etc.

For example, navigation data (which may include map data, casino layout data, camera image data, etc.) may be provided by one or more of the servers of computer room 620 to mobile devices 670. Some implementations of the present invention include a plurality of networked cameras 609, which may be video cameras, smart cameras, digital still cameras, etc. In some such implementations, such cameras may provide, at least in part, real-time navigation features such as those described in U.S. patent application Ser. No. 12/106,771 (attorney docket no. IGT1P410/P-1222), entitled “Real-Time Navigation Devices, Systems and Methods,” which is incorporated herein by reference.

Other devices that may be deployed in network 605 do not appear in FIG. 6. For example, some gaming networks may include not only various radio frequency identification (“RFID”) readers 617, but also RFID switches, middleware servers, etc., some of which are not depicted in FIG. 6. These features may provide various functions. For example, a server (or another device) may determine a location of a mobile device 670 according to the location of an RFID reader that reads an RFID tag 627.

The servers and other devices indicated in FIG. 6 may be configured for communication with other devices in or outside of gaming establishment 605, such as host devices 660, kiosks 677 and/or mobile devices 670, for implementing some methods described elsewhere herein. Servers (or the like) may facilitate communications with such devices, receive and store patron data, provide appropriate responses, etc., as described elsewhere herein.

Some of these servers may be configured to perform tasks relating to accounting, player loyalty, bonusing/progressives, configuration of gaming machines, etc. One or more such devices may be used to implement a casino management system, such as the IGT Advantage™ Casino System suite of applications, which provides instantaneous information that may be used for decision-making by casino managers. A Radius server and/or a DHCP server may also be configured for communication with the gaming network. Some implementations of the invention provide one or more of these servers in the form of blade servers.

Some preferred embodiments of sb™ server 630 and the other servers shown in FIG. 6 include (or are at least in communication with) clustered CPUs, redundant storage devices, including backup storage devices, switches, etc. Such storage devices may include a “RAID” (originally redundant array of inexpensive disks, now also known as redundant array of independent disks) array, back-up hard drives and/or tape drives, etc.

In some implementations of the invention, many of these devices (including but not limited to License Manager 631, servers 632, 634, 636 and 638, and main network device 625) are mounted in a single rack with sb™ server 630. Accordingly, many or all such devices will sometimes be referenced in the aggregate as an “sb™ server.” However, in alternative implementations, one or more of these devices is in communication with sb™ server 630 and/or other devices of the network but located elsewhere. For example, some of the devices could be mounted in separate racks within computer room 620 or located elsewhere on the network. Moreover, it can be advantageous to store large volumes of data elsewhere via a storage area network (“SAN”).

Computer room 620 may include one or more operator consoles or other host devices that are configured for communication with other devices within and outside of computer room 620. Such host devices may be provided with software, hardware and/or firmware for implementing various aspects of the invention. However, such host devices need not be located within computer room 620. Wired host devices 660 (which are desktop and laptop computers in this example) and wireless devices 670 (which are PDAs in this example) may be located elsewhere in gaming establishment 605 or at a remote location.

Some embodiments of the invention include devices for implementing access control, security and/or other functions relating to the communication between different devices on the network. In this example, arbiter 633 serves as an intermediary between different devices on the network. Arbiter 633 may be implemented, for example, via software that is running on a server or another networked device. Some implementations of Arbiter 633 are described in U.S. patent application Ser. No. 10/948,387, entitled “METHODS AND APPARATUS FOR NEGOTIATING COMMUNICATIONS WITHIN A GAMING NETWORK” and filed Sep. 23, 2004 (the “Arbiter Application”), which is incorporated herein by reference and for all purposes. In some preferred implementations, Arbiter 633 is a repository for the configuration information required for communication between devices on the gaming network (and, in some implementations, devices outside the gaming network). Although Arbiter 633 can be implemented in various ways, one example implementation is discussed in the following paragraphs.

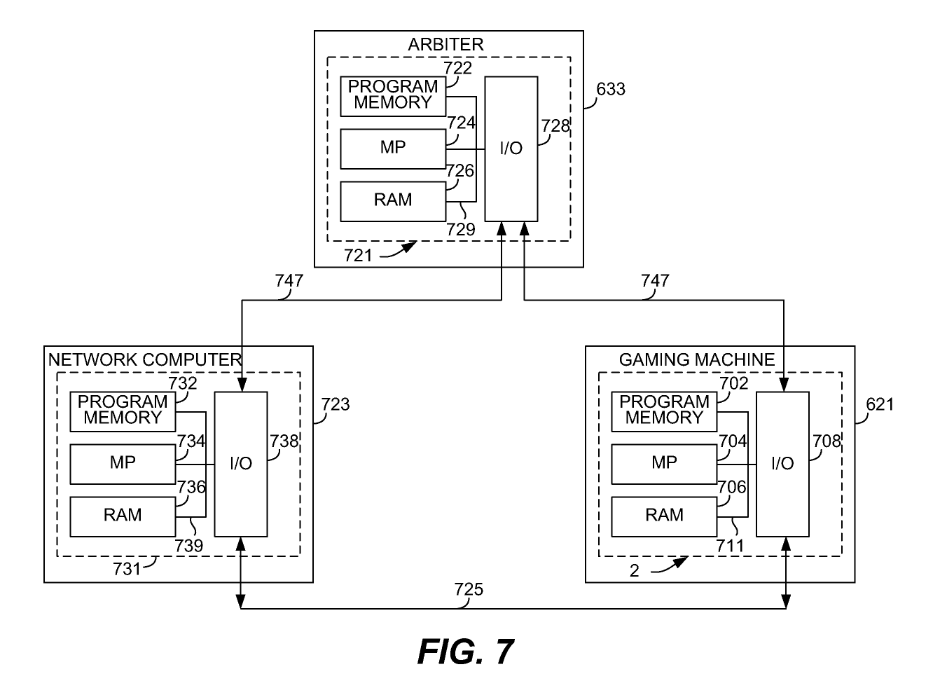

FIG. 7 is a block diagram of a simplified communication topology between gaming machine 621, network computer 723 and Arbiter 633. Network computer 723 may be, for example, a server or other device within computer room 620 or elsewhere. Although only one gaming machine 621, one network computer 723 and one Arbiter 633 are shown in FIG. 7, it should be understood that the following examples may be applicable to different types of networked devices in addition to gaming machine 621 and network computer 723, and may include different numbers of network computers 723, Arbiters 633 and gaming machines 621. For example, a single Arbiter 633 may be used for secure communications among a plurality of network computers 723 and tens, hundreds or thousands of gaming machines 621. Likewise, multiple Arbiters 633 may be utilized for improved performance and other scalability factors.

Referring to FIG. 7, the Arbiter 633 may include an arbiter controller 721 that may comprise a program memory 722, a microcontroller or microprocessor (MP) 724, a random-access memory (RAM) 726 and an input/output (I/O) circuit 728, all of which may be interconnected via an address/data bus 729. The network computer 723 may also include a controller 731 that may comprise a program memory 732, a microcontroller or microprocessor (MP) 734, a random-access memory (RAM) 736 and an input/output (I/O) circuit 738, all of which may be interconnected via an address/data bus 739. It should be appreciated that although the Arbiter 633 and the network computer 723 are each shown with only one microprocessor 724, 734, the controllers 721, 731 may each include multiple microprocessors 724, 734. Similarly, the memory of the controllers 721, 731 may include multiple RAMs 726, 736 and multiple program memories 722, 732. Although the I/O circuits 728, 738 are each shown as a single block, it should be appreciated that the I/O circuits 728, 738 may include a number of different types of I/O circuits. The RAMs 724, 734 and program memories 722, 732 may be implemented as semiconductor memories, magnetically readable memories, and/or optically readable memories, for example.

Although the program memories 722, 732 are shown in FIG. 7 as read-only memories (ROM) 722, 732, the program memories of the controllers 721, 731 may be a read/write or alterable memory, such as a hard disk. In the event a hard disk is used as a program memory, the address/data buses 729, 739 shown schematically in FIG. 7 may each comprise multiple address/data buses, which may be of different types, and there may be an I/O circuit disposed between the address/data buses.

As shown in FIG. 7, the gaming machine 621 may be operatively coupled to the network computer 723 via the data link 725. The gaming machine 621 may also be operatively coupled to the Arbiter 633 via the data link 749, and the network computer 723 may likewise be operatively coupled to the Arbiter 633 via the data link 747.

Communications between the gaming machine 621 and the network computer 723 may involve different information types of varying levels of sensitivity resulting in varying levels of encryption techniques depending on the sensitivity of the information. For example, communications such as drink orders and statistical information may be considered less sensitive. A drink order or statistical information may remain encrypted, although with moderately secure encryption techniques, such as RC4, resulting in less processing power and less time for encryption. On the other hand, financial information (e.g., account information, winnings, etc.), download information (e.g., game and/or peripheral software, licensing information, etc.) and personal information (e.g., social security number, personal preferences, etc.) may be encrypted with stronger encryption techniques such as DES or 3DES to provide increased security.

As disclosed in further detail in the Arbiter Application, the Arbiter 633 may verify the authenticity of devices in the gaming network, including but not limited to devices sending queries and/or remote procedure calls to gaming machines. The Arbiter 633 may receive a request for a communication session from a network device. For ease of explanation, the requesting network device may be referred to as the client, and the requested network device may be referred to as the host. The client may be any device on the network and the request may be for a communication session with any other network device. The client may specify the host, or the gaming security arbiter may select the host based on the request and based on information about the client and potential hosts. The Arbiter 633 may provide encryption keys (session keys) for the communication session to the client via the secure communication channel. Either the host and/or the session key may be provided in response to the request, or may have been previously provided. The client may contact the host to initiate the communication session. The host may then contact the Arbiter 633 to determine the authenticity of the client. The Arbiter 633 may provide affirmation (or lack thereof) of the authenticity of the client to the host and provide a corresponding session key, in response to which the network devices may initiate the communication session directly with each other using the session keys to encrypt and decrypt messages.

Alternatively, upon receiving a request for a communication session, the Arbiter 633 may contact the host regarding the request and provide corresponding session keys to both the client and the host. The Arbiter 633 may then initiate either the client or the host to begin their communication session. In turn, the client and host may begin the communication session directly with each other using the session keys to encrypt and decrypt messages. An additional explanation of the communication request, communication response and key distribution is provided in the Arbiter Application.

Referring again to FIG. 6, the communication link(s) between casino 605 and central system 663 preferably have ample bandwidth and may, for example, comprise one or more T1 or T3 connections and/or satellite links having comparable bandwidth, etc. Network 629 is the Internet in this example. However, it will be understood by those of skill in the art that network 629 could include any one of various types of networks, such as the public switched telephone network (“PSTN”), a satellite network, a wireless network, a metro optical transport, etc. Accordingly, a variety of protocols may be used for communication on network 629, such as Internet Protocol (“IP”), Fibre Channel (“FC”), FC over IP (“FCIP”), Internet SCSI (“iSCSI,” an IP-based standard for linking data storage devices over a network and transferring data by carrying SCSI commands over IP networks) or Dense Wavelength Division Multiplexing (“DWDM,” an optical technology used to increase bandwidth over existing fiber optic backbones).

If a host device is located in a remote location, security methods and devices (such as firewalls, authentication and/or encryption) should be deployed in order to prevent the unauthorized access of the gaming network.

Similarly, any other connection between gaming network 605 and the outside world should only be made with trusted devices via a secure link, e.g., via a virtual private network (“VPN”) tunnel. For example, the illustrated connection between sb™ server 630, gateway 650 and central system 663 (that may be used for communications involving peripheral device software downloads, etc.) is advantageously made via a VPN tunnel. Details of VPN methods that may be used with the present invention are described in the reference, “Virtual Private Networks-Technologies and Solutions,” by R. Yueh and T. Strayer, Addison-Wesley, 2001, ISBN #0-201-70209-6, which is incorporated herein by reference and for all purposes. Additionally VPNs may be implemented using a variety of protocols, such as, for example, IP Security (IPSec) Protocol, Layer 2 Tunneling Protocol, Multiprotocol Label Switching (MPLS) Protocol, etc. Details of these protocols, including RFC reports, may be obtained from the VPN Consortium, an industry trade group (http://www.vpnc.com, VPNC, Santa Cruz, Calif.).

Alternatively, a permanent virtual circuit (“PVC”) can be established to provide a dedicated and secure circuit link between two facilities, e.g., between a casino and central system 663. A PVC is a virtual circuit established for repeated use between the same data terminals. A PVC could be provided, for example, via AT&T′s Asynchronous Transfer Mode (“ATM”) switching fabric. Some implementations provide a dedicated line from an endpoint (e.g., from casino 605) into the ATM backbone. Other implementations provide a connection over another network (e.g., the Internet) between an endpoint and the nearest device of the ATM backbone, e.g., to the nearest edge router. In some such implementations, the fixed-sized cells used in the ATM switching fabric may be encapsulated in variable sized packets (such as Internet Protocol or Ethernet packets) for transmission to and from the ATM backbone.

For security purposes, information transmitted to, on or from a gaming establishment may be encrypted. In one implementation, the information may be symmetrically encrypted using a symmetric encryption key, where the symmetric encryption key is asymmetrically encrypted using a private key. The public key may, for example, be obtained from a remote public key server. The encryption algorithm may reside in processor logic stored on the gaming machine. When a remote server receives a message containing the encrypted data, the symmetric encryption key is decrypted with a private key residing on the remote server and the symmetrically encrypted information sent from the gaming machine is decrypted using the symmetric encryption key. A different symmetric encryption key is used for each transaction where the key is randomly generated. Symmetric encryption and decryption is preferably applied to most information because symmetric encryption algorithms tend to be 100-10,000 faster than asymmetric encryption algorithms.

Some network implementations may use Trusted Network Connect (“TNC”), which is an open architecture provided by the Trusted Network Connect Sub Group (“TNC-SG”) of the Trusted Computing Group (TCG). TNC enables network operators to provide endpoint integrity at every network connection, thus enabling interoperability among multi-vendor network endpoints. Alternatively, or additionally, the Secure Internet File Transfer (“SIFT”) may be employed. SIFT allows devices to send and receive data over the Internet in a secure (128-bit encryption) method of transport.

Providing secure connections between devices in a gaming network, such as the connections between the local devices of the gaming network 605 and central system 663, allows for the deployment of many advantageous features. For example, a customer (e.g., an employee of a gaming establishment) may be able to log onto an account of central system 663 to obtain the account information such as the customer's current and prior account status. Automatic updates of a customer's software may also be enabled. For example, central system 663 may notify one or more devices in gaming establishment 605 regarding new products and/or product updates. For example, central system 663 may notify server (or other device) in computer room 620 regarding new software, software updates, the status of current software licenses, etc. Alternatively, such updates could be automatically provided to a server in computer room 620 and downloaded to networked gaming machines.

After the local server receives this information, relevant products of interest may be identified (by the server, by another device or by a human being). If an update or a new software product is desired, it can be downloaded from the central system. Similarly, a customer may choose to renew a software license via a secure connection with central system 663, e.g., in response to a notification that the software license is required.

In addition, providing secure connections between different gaming establishments can enable alternative implementations of the invention. For example, a number of gaming establishments may be owned and/or controlled by the same entity. In such situations, having secure communications between gaming establishments makes it possible for a gaming entity to use one or more servers in a gaming establishment as an interface between central system 663 and gaming machines in multiple gaming establishments. For example, new or updated software may be obtained by a server in one gaming establishment and distributed to gaming machines in that gaming establishment and/or other gaming establishments. A server in one gaming establishment may perform services, such as patron identification services, in response to a request from a device in another gaming establishment.

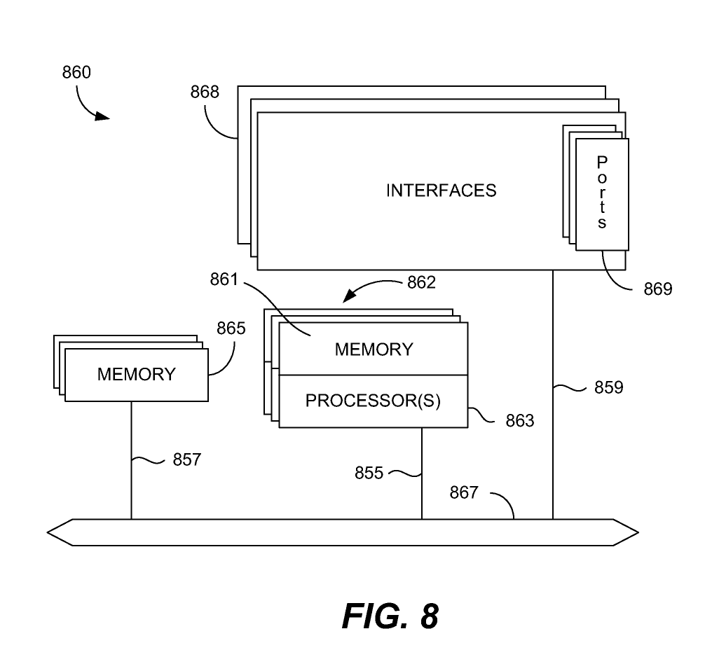

FIG. 8 illustrates an example of a network device that may be configured for implementing some methods of the present invention. Network device 860 includes a master central processing unit (CPU) 862, interfaces 868, and a bus 867 (e.g., a PCI bus). Generally, interfaces 868 include ports 869 appropriate for communication with the appropriate media. In some embodiments, one or more of interfaces 868 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 868 control such communications-intensive tasks as encryption, decryption, compression, decompression, packetization, media control and management. By providing separate processors for the communications-intensive tasks, interfaces 868 allow the master microprocessor 862 efficiently to perform other functions such as routing computations, network diagnostics, security functions, etc.

The interfaces 868 are typically provided as interface cards (sometimes referred to as “linecards”). Generally, interfaces 868 control the sending and receiving of data packets over the network and sometimes support other peripherals used with the network device 860. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 862 may be responsible for implementing specific functions associated with the functions of a desired network device. According to some embodiments, CPU 862 accomplishes all these functions under the control of software including an operating system and any appropriate applications software.

CPU 862 may include one or more processors 863 such as a processor from the Motorola family of microprocessors or the MIPS family of microprocessors. In an alternative embodiment, processor 863 is specially designed hardware for controlling the operations of network device 860. In a specific embodiment, a memory 861 (such as non-volatile RAM and/or ROM) also forms part of CPU 862. However, there are many different ways in which memory could be coupled to the system. Memory block 861 may be used for a variety of purposes such as, for example, caching and/or storing data, programming instructions, etc.

Regardless of network device's configuration, it may employ one or more memories or memory modules (such as, for example, memory block 865) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 8 illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 8) or switch fabric based (such as a cross-bar).

The above-described devices and materials will be familiar to those of skill in the gaming industry and/or in the computer hardware and software arts. Although many of the components and processes are described above in the singular for convenience, it will be appreciated by one of skill in the art that multiple components and repeated processes can also be used to practice the techniques of the present invention.

Although illustrative embodiments and applications of this invention are shown and described herein, many variations and modifications are possible which remain within the concept, scope, and spirit of the invention, and these variations should become clear after perusal of this application. Accordingly, the present embodiments are to be considered as illustrative and not restrictive, and the invention is not to be limited to the details given herein, but may be modified within the scope and equivalents of the appended claims.

We claim:

1. A gaming apparatus comprising:
a main processor board;
a CPU operable to execute game logic that implements a game of chance;
a motion generating device;
a first memory configured to store at least one first motion control profile that describes movement of the motion generating device;
a motion control board coupled to the main processor board by an interface bus, the motion control board including:
a second memory configured to store at least one second motion control profile, and
transfer logic configured to do the following:
receive the at least one first motion control profile in response to a gaming event,
generate the at least one second motion control profile based upon the at least one first motion control profile, and
store the at least one second motion control profile in the second memory; and
motion control logic configured to cause the motion generating device to move in accordance with the at least one second motion control profile.

2. The gaming apparatus of claim 1, wherein the at least one second motion control profile is a copy of the at least one first motion control profile.

3. The gaming apparatus of claim 1, wherein the transfer logic is further configured to receive the at least one first motion control profile via the interface bus.

4. The gaming apparatus of claim 1, wherein the gaming event comprises receiving input from a player input device.

5. The gaming apparatus of claim 1, wherein the gaming event comprises receiving new or updated game logic.

6. The gaming apparatus of claim 1, wherein the at least one first motion control profile includes at least one predetermined time value.

7. The gaming apparatus of claim 6, wherein the motion generating device is a stepper motor, and
the motion control logic is configured to cause the stepper motor to rotate by a step for each individual time value included in the second motion control profile when a period of time corresponding to and based upon the individual time value has elapsed.

8. The gaming apparatus of claim 1, wherein the at least one second motion control profile comprises a first labeled profile associated with a first label, and
the motion control logic is configured to cause the motion generating device to move in accordance with the first labeled profile in response to receiving from the CPU a motion control command that includes the first label.

9. The gaming apparatus of claim 8, wherein the at least one second motion control profile further comprises a second labeled profile associated with a second label, and
the motion control logic is configured to cause the motion generating device to move in accordance with the second labeled profile in response to receiving from the CPU a motion control command that includes the second label.

10. The gaming apparatus of claim 1, wherein the bus is a Universal Serial Bus (USB).

11. The gaming apparatus of claim 1, wherein the transfer logic is located on the main processor board, the motion control board, or a combination thereof.

12. The gaming apparatus of claim 1, further comprising:
a network interface operable to receive the at least one first motion control profile from a server-based network,
wherein the gaming event comprises receiving the at least one first motion control profile from the server-based network.

13. The gaming apparatus of claim 1, wherein the at least one first motion control profile is verified to be within the performance capabilities of the motion generating device.

14. A gaming machine operable to play a game of chance, the gaming machine comprising:
a main processor board;
a CPU operable to execute game logic that implements a game of chance;
a motion generating device;
a first memory configured to store at least one first motion control profile;
a second memory configured to store at least one second motion control profile,
wherein the first and second motion control profiles describe movement of the motion generating device;
a value input device capable of receiving value;
a player input device operable to place a wager on the game of chance;
a value output device capable of outputting value associated with play of the game of chance; and
a controller coupled to the main processor board by an interface bus, the controller configured to:
receive the at least one first motion control profile in response to a gaming event;
generate the at least one second motion control profile based upon the at least one first motion control profile;
store the at least one second motion control profile in the second memory; and
cause the motion generating device to move in accordance with the at least one second motion control profile.

15. The gaming machine of claim 14, wherein the at least one second motion control profile is a copy of the at least one first motion control profile.

16. The gaming machine of claim 14, wherein the controller is further configured to receive the at least one first motion control profile via the interface bus.

17. The gaming machine of claim 14, wherein the gaming event comprises receiving input via the player input device.

18. The gaming machine of claim 14, wherein the gaming event comprises receiving new or updated game logic.

19. The gaming machine of claim 14, wherein the at least one first motion control profile includes at least one predetermined time value.

20. The gaming machine of claim 19, wherein the motion generating device is a stepper motor, and
the controller is further configured to cause the stepper motor to rotate by a step for each individual time value included in the second motion control profile when a period of time corresponding to and based upon the individual time value has elapsed.

21. The gaming machine of claim 14, wherein the at least one second motion control profile comprises a first labeled profile associated with a first label, and
the controller is further configured to cause the motion generating device to move in accordance with the first labeled profile in response to receiving from the CPU a motion control command that includes the first label.

22. The gaming machine of claim 21, wherein the at least one second motion control profile further comprises a second labeled profile associated with a second label, and
the controller is further configured to cause the motion generating device to move in accordance with the second labeled profile in response to receiving from the CPU a motion control command that includes the second label.

23. The gaming machine of claim 14, wherein the bus is a Universal Serial Bus (USB).

24. The gaming machine of claim 14, further comprising:
a network interface operable to receive the at least one first motion control profile from a server-based network,
wherein the gaming event comprises receiving the at least one first motion control profile from the server-based network.

25. The gaming machine of claim 14, wherein the at least one first motion control profile is verified to be within the performance capabilities of the motion generating device.

26. A system, comprising:
a host device;
a plurality of gaming machines operable to play games of chance, each gaming machine comprising:
a main processor board;
a CPU operable to execute game logic that implements a game of chance;
a motion generating device;
a first memory configured to store at least one first motion control profile;
a second memory configured to store at least one second motion control profile,
wherein the first and second motion control profiles describe movement of the motion generating device;
a value input device capable of receiving value,
a player input device operable to place a wager on the game of chance,
a value output device capable of outputting value associated with play of the game of chance,
a memory configured to store a transaction log file containing one or more log entries, and
a controller coupled to the main processor board by an interface bus, the controller configured to:
receive the at least one first motion control profile in response to a gaming event;
generate the at least one second motion control profile based upon the at least one first motion control profile;
store the at least one second motion control profile in the second memory; and
cause the motion generating device to move in accordance with the at least one second motion control profile.

27. The system of claim 26, wherein the at least one second motion control profile is a copy of the at least one first motion control profile.

28. The system of claim 26, wherein the controller is further configured to receive the at least one first motion control profile via the interface bus.

29. The system of claim 26, wherein the gaming event comprises receiving input via the player input device.

30. The system of claim 26, wherein the gaming event comprises receiving new or updated game logic.

31. The system of claim 26, wherein the at least one first motion control profile includes at least one predetermined time value.

32. The system of claim 26, wherein the motion generating device is a stepper motor, and
the controller is configured to cause the stepper motor to rotate by a step for each individual time value included in the second motion control profile when a period of time corresponding to and based upon the individual time value has elapsed.

33. The system of claim 26, wherein the at least one second motion control profile comprises a first labeled profile associated with a first label, and
the controller is configured to cause the motion generating device to move in accordance with the first labeled profile in response to receiving from the CPU a motion control command that includes the first label.

34. The system of claim 33, wherein the at least one second motion control profile further comprises a second labeled profile associated with a second label, and
the controller is configured to cause the motion generating device to move in accordance with the second labeled profile in response to receiving from the CPU a motion control command that includes the second label.

35. The system of claim 26, wherein the bus is a Universal Serial Bus (USB).

36. The system of claim 26, further comprising:
a network interface operable to receive the at least one motion control profile from a server-based network,
wherein the controller is further configured to cause the at least one motion control profile to be transferred to the second memory in response to receipt of the at least one motion control profile by the network interface.

37. The system of claim 26, wherein the at least one first motion control profile is verified to be within the performance capabilities of the motion generating device.
